(19) United States
(12) Patent Application Publication
(10) Pub. No.: US 2021/0118662 A1
(43) Pub. Date: Apr. 22, 2021

(54) MASS SPECTROMETER

(71) Applicant: SHIMADZU CORPORATION, Kyoto-shi (JP)

(72) Inventor: Yusuke SAKAGOSHI, Kyoto-shi (JP)

(73) Assignee: SHIMADZU CORPORATION, Kyoto-shi (JP)

(21) Appl. No.: 17/015,457

(22) Filed: Sep. 9, 2020

(30) Foreign Application Priority Data
Oct. 16, 2019 (JP) 2019-189276

(51) Int. Cl. H01J 49/04

(52) U.S. Cl. CPC H01J 49/0468; H01J 49/0431

(57) ABSTRACT

A connection pipe penetrates a partition wall, and communicatively connects an ionization chamber to a vacuum chamber. A heating block is arranged in the ionization chamber, and heats the connection pipe by surrounding an outer periphery of the connection pipe. The connection pipe is inserted into a flange member, and the flange member abuts on an end surface of the heating block. The flange member includes a base portion and a projection portion. The base portion abuts on the end surface of the heating block, and is arranged in the ionization chamber. The projection portion projects from the base portion.

### CROSS REFERENCE TO RELATED APPLICATION

This application claims priority to Japanese Patent Application No. 2019-189276 filed on Oct. 16, 2019, the entire disclosure of which is incorporated by reference herein.

### BACKGROUND OF THE INVENTION

### Field of the Invention

The present invention relates to a mass spectrometer.

### Description of the Related Art

An ionization chamber that ionizes a sample and a vacuum chamber into which ions generated in the ionization chamber are introduced are provided at a mass spectrometer (for example, see JP-B-4453537). The ionization chamber and the vacuum chamber are arranged adjacent to each other, and are partitioned by a partition wall provided therebetween. The ions generated in the ionization chamber flow into the vacuum chamber from the ionization chamber via a connection pipe formed as a thin pipe penetrating the partition wall.

The connection pipe is heated by a heating block that surrounds an outer periphery of the connection pipe. The heating block is provided on the ionization chamber side. A tip portion of the connection pipe on an outlet side projects from the heating block, and the projection portion is inserted into the vacuum chamber.

### SUMMARY OF THE INVENTION

As described above, the tip portion of the connection pipe is inserted into the vacuum chamber. However, since the heating block is provided on the ionization chamber side, the tip portion of the connection pipe cannot be heated.

The present invention has been made in view of the above circumstances, and an object of the present invention is to provide a mass spectrometer capable of heating a tip portion of a connection pipe.

A first aspect of the present invention is a mass spectrometer including an ionization chamber, a vacuum chamber, a partition wall, a connection pipe, a heating block, and a flange member. The ionization chamber ionizes a sample. Ions generated in the ionization chamber are introduced into the vacuum chamber. The partition wall partitions the ionization chamber from the vacuum chamber. The connection pipe penetrates the partition wall, and communicatively connects the ionization chamber to the vacuum chamber. The heating block is arranged in the ionization chamber, and heats the connection pipe by surrounding an outer periphery of the connection pipe. The connection pipe is inserted into the flange member, and abuts on a first end surface of the heating block. The flange member includes a base portion and a projection portion. The base portion abuts on the first end surface of the heating block, and is arranged in the ionization chamber. The projection portion projects from the base portion.

According to the first aspect of the present invention, the connection pipe can be heated via the flange member that abuts the heating block. Since the flange member includes the projection portion, the tip portion of the connection pipe can be heated via the projection portion.

### BRIEF DESCRIPTION OF THE DRAWINGS

FIG. 1 is a schematic diagram illustrating an embodiment of a mass spectrometer;

FIG. 2 is a schematic cross-sectional view illustrating an example of a configuration around a connection pipe; and

FIG. 3 is a schematic cross-sectional view illustrating an enlarged configuration around a flange member in detail.

### DETAILED DESCRIPTION OF THE PREFERRED EMBODIMENTS

### 1. Overall Configuration of Mass Spectrometer

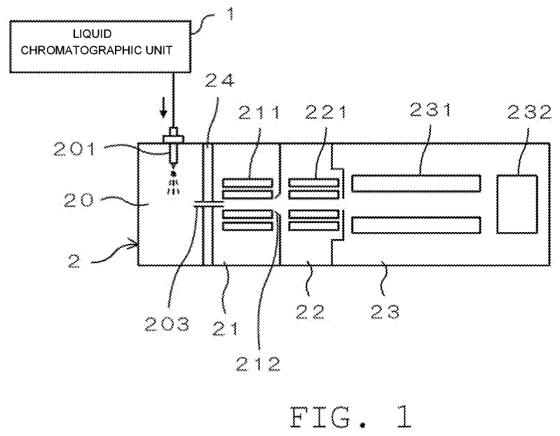

FIG. 1 is a schematic diagram illustrating an embodiment of a mass spectrometer. The mass spectrometer illustrated in FIG. 1 is a liquid chromatograph mass spectrometer that performs mass spectrometry on components in a sample separated by liquid chromatography. This mass spectrometer includes a liquid chromatographic unit 1 and a mass spectrometric unit 2.

The liquid chromatographic unit 1 includes a column (not illustrated). During spectrometry, a mobile phase containing an organic solvent such as acetonitrile or methanol is introduced into the column. A predetermined amount of sample is injected into the mobile phase introduced into the column. The mobile phase into which the sample is injected is introduced into the column, and the components in the sample are separated in the process of passing through the column. The components in the sample separated by the column are sequentially supplied to the mass spectrometric unit 2.

An ionization chamber 20, a first vacuum chamber 21, a second vacuum chamber 22, and a spectrometric chamber 23 are formed in the mass spectrometric unit 2. The inside of the ionization chamber 20 is substantially at an atmospheric pressure. The first vacuum chamber 21, the second vacuum chamber 22, and the spectrometric chamber 23 are brought into a vacuum state by driving a vacuum pump (not illustrated). The ionization chamber 20, the first vacuum chamber 21, the second vacuum chamber 22, and the spectrometric chamber 23 are communicatively connected to each other, and are configured such that degrees of vacuum are gradually increased in this order.

A probe 201 is provided in the ionization chamber 20. The probe 201 sprays a liquid sample by, for example, an electrospray ionization (ESI) method. In the probe 201, the sample is charged by applying electric charges to the sample, and ions derived from the components in the sample are generated. As stated above, in the ionization chamber 20, the sample supplied from the liquid chromatographic unit 1 is ionized.

The first vacuum chamber 21 is communicatively connected to the ionization chamber 20 via a connection pipe 203 formed as a thin pipe. The ionization chamber 20 and the first vacuum chamber 21 are partitioned by a partition wall 24, and the connection pipe 203 penetrates the partition wall 24. The second vacuum chamber 22 is communicatively connected to the first vacuum chamber 21 via a skimmer 212 having small holes.

The ions generated in the ionization chamber 20 are introduced into the first vacuum chamber 21 via the connection pipe 203, and then flow into the second vacuum chamber 22 through the skimmer 212. Ion guides 211 and 221 for sending the ions to subsequent stage while converging the ions are provided at the first vacuum chamber 21 and the second vacuum chamber 22, respectively. However, the number of vacuum chambers communicatively connected to the ionization chamber 20 is not limited to two, and may be one or three or more.

For example, a quadrupole filter 231 and a detector 232 are provided at the spectrometric chamber 23. The ions flowing into the spectrometric chamber 23 from the second vacuum chamber 22 are separated by the quadrupole filter 231 according to a mass-to-charge ratio, and only ions having a specific mass-to-charge ratio pass through the quadrupole filter 231. The ions passed through the quadrupole filter 231 are incident on the detector 232. The detector 232 outputs, as a detection signal, a current corresponding to the number of arrived ions.

### 2. Configuration Around Connection Pipe

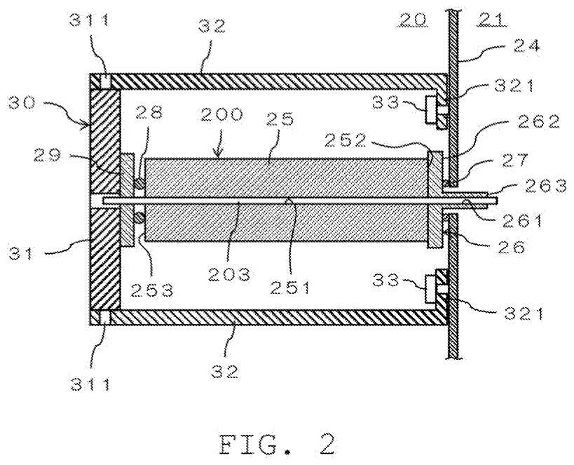

FIG. 2 is a schematic cross-sectional view illustrating an example of a configuration around the connection pipe 203. The connection pipe 203 is made of a metal such as stainless steel. The connection pipe 203 constitutes a desolvating unit 200 in cooperation with a heating block 25 and a flange member 26. The desolvating unit 200 removes solvent components in charged droplets generated in the ionization chamber 20 by heating.

The heating block 25 is arranged in the ionization chamber 20. The heating block 25 is made of, for example, a metal having a high thermal conductivity such as aluminum, and the connection pipe 203 penetrates a central portion of the heating block. That is, a through hole 251 extending in a longitudinal direction of the heating block is formed in the heating block 25, and an outer periphery of the connection pipe 203 is surrounded by the heating block 25 by inserting the connection pipe 203 so as to come into contact with an inner peripheral surface of the through hole 251. A heater (not illustrated) is in contact with the heating block 25. Heat of this heater is transferred to the connection pipe 203 via the heating block 25, and thus, the connection pipe 203 is heated.

The connection pipe 203 projects from an end surface (first end surface) 252 of the heating block 25 on the first vacuum chamber 21 side. The flange member 26 abuts on the end surface 252 of the heating block 25. A through hole 261 is formed in the flange member 26, and an end portion of the connection pipe 203 is inserted so as to come into contact with an inner peripheral surface of the through hole 261. The flange member 26 is fixed to the connection pipe 203 by welding a part of the flange member to the connection pipe 203. The flange member 26 can be made of, for example, a metal such as aluminum or stainless steel, but may be made of the same material as the material of the connection pipe 203 from the viewpoint of satisfactorily performing welding with the connection pipe 203.

The flange member 26 has a configuration in which a base portion 262 and a projection portion 263 are integrally formed. The base portion 262 of the flange member 26 is, for example, a plate-shaped member, and abuts on the entire end surface 252 of the heating block 25. Accordingly, the heat can be satisfactorily transferred from the end surface 252 of the heating block 25 to the flange member 26 via the base portion 262. The base portion 262 of the flange member 26 is arranged in the ionization chamber 20.

The projection portion 263 of the flange member 26 projects from a central portion of the base portion 262 to the first vacuum chamber 21 side (a side opposite to the heating block 25 side). A tip portion of the projection portion 263 is inserted into the vacuum chamber 21. The projection portion 263 is a tubular member, and the inside of the projection portion 263 constitutes a part of the through hole 261. That is, the through hole 261 is formed so as to penetrate the base portion 262 and the projection portion 263 in a straight line.

A seal member (first seal member) 27 is arranged between the base portion 262 of the flange member 26 and the partition wall 24. The seal member 27 is, for example, an O-ring, and abuts on a surface of the base portion 262 (a surface on the side opposite to the heating block 25 side) in a state in which the projection portion 263 is inserted into the seal member 27.

The connection pipe 203 projects from an end surface (second end surface) 253 of the heating block 25 on a side opposite to the first vacuum chamber 21 side. A seal member (second seal member) 28 abuts on the end surface 253 of the heating block 25. The seal member 28 is, for example, an O-ring, and the connection pipe 203 projecting from the heating block 25 is inserted into the seal member 28. A cross-sectional area of the seal member 28 is larger than a cross-sectional area of the seal member 27.

An end member 29 is provided on the side opposite to the heating block 25 side with respect to the seal member 28. The end member 29 is a plate-shaped member, and the connection pipe 203 penetrates a central portion of the end member 29. The seal member 28 is arranged between the end surface 253 of the heating block 25 and the end member 29. The end member 29 is slidable with respect to the connection pipe 203.

The end member 29 is pressed against the heating block 25 side by a pressing mechanism 30. The pressing mechanism 30 includes a pressing portion 31 and a fixation portion 32. The pressing portion 31 presses the end surface 253 of the heating block 25 toward the first vacuum chamber 21 side via the end member 29 and the seal member 28 by pressing the end member 29. Accordingly, the seal members 27 and 28 are compressed and elastically deformed. As a result, a space between the flange member 26 and the partition wall 24 is sealed by the seal member 27. A space between the heating block 25 and the end member 29 is sealed by the seal member 28.

The fixation portion 32 maintains a state in which the pressing portion 31 presses the end surface 253 of the heating block 25 by fixing the pressing portion 31. In this example, the fixation portion 32 is a lever member that can be displaced with respect to the pressing portion 31. Specifically, the fixation portion 32 is provided rotatably around a rotation shaft 311 with respect to the pressing portion 31. A hook portion 321 is formed at a tip portion of the fixation portion 32. The pressing portion 31 can be fixed in a state in which the end surface 253 of the heating block 25 is pressed by the pressing portion 31 by rotating the fixation portion 32 and engaging the hook portion 321 with a pin 33 provided at another member such as the partition wall 24.

Although two fixation portions 32 are illustrated in FIG. 2, the number of fixation portions 32 may be one, or may be three or more. The fixation portion 32 is not limited to the configuration in which the fixation portion 32 is rotatable about the rotation shaft 311, but may be, for example, a configuration in which the fixation portion 32 is slidable or a configuration in which the fixation portion 32 is displaced in another aspect such as a screwing type or a fitting type. That is, the pressing mechanism 30 is not limited to the configuration illustrated in FIG. 2 as long as the pressing mechanism can press the end surface 253 of the heating block 25 toward the first vacuum chamber 21 side.

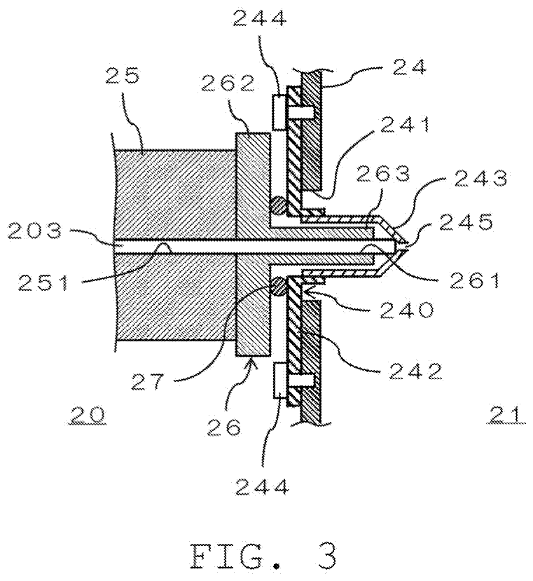

FIG. 3 is a schematic cross-sectional view illustrating an enlarged configuration around the flange member 26 in detail. An opening 241 for inserting the connection pipe 203 is formed in the partition wall 24. An orifice member 240 is provided in this opening 241.

The orifice member 240 includes a fixation portion 242 fixed to the partition wall 24, and a tubular portion 243 attached to the fixation portion 242. The fixation portion 242 is made of resin, for example, and is fixed to the partition wall 24 by using a fixing tool 244 such as a screw. The tubular portion 243 is made of metal, for example, and is attached by being screwed into the fixation portion 242. However, the tubular portion 243 is not limited to the screwing type, and may be attached to the fixation portion 242 by, for example, a fitting type, or may be integrally formed with the fixation portion 242. The seal member 27 is sandwiched between the base portion 262 of the flange member 26 and the fixation portion 242.

The projection portion 263 of the flange member 26 extends into the tubular portion 243. A tip portion of the tubular portion 243 is formed in a tapered shape tapered toward the first vacuum chamber 21 side, and an opening 245 is formed at this tip portion. An inner diameter of the opening 245 is smaller than an outer diameter of the connection pipe 203. The tip portion (outlet-side end portion) of the connection pipe 203 abuts the tubular portion 243 from an inside at a peripheral edge of the opening 245.

A tip portion of the projection portion 263 of the flange member 26 is located near the tip portion of the connection pipe 203. A position of the tip portion of the projection portion 263 may be the same position as the tip portion of the connection pipe 203, or may be located on the ionization chamber 20 side by a slight amount (for example, about 0.5 to 10 mm) from the tip portion of the connection pipe 203.

### 3. Modification Example

The projection portion 263 of the flange portion 26 is not limited to the configuration in which the tip portion is inserted into the vacuum chamber 21, and the tip portion may be located in the ionization chamber 20. The base portion 262 of the flange member 26 may include another member (heat transfer member) arranged between the base portion 262 of the flange member 26 and the end surface 252 of the heating block 25.

It has been described in the embodiment that the plurality of vacuum chambers is provided in the mass spectrometric unit 2. However, only one vacuum chamber may be provided. In the ionization chamber 20, the configuration to spray and ionize the liquid sample is not limited to the ESI method, but the liquid sample may be sprayed and ionized by another method such as the atmospheric pressure chemical ionization (APCI) method.

The mass spectrometer is not limited to the liquid chromatograph mass spectrometer, and may have a configuration in which the sample is introduced from a sample introduction unit other than the liquid chromatographic unit 1, for example. The sample may be ionized inside the mass spectrometer by using another method such as matrix assisted laser desorption/ionization (MALDI).

### 4. Aspects

It will be appreciated by those of skill in the art that the plurality of exemplary embodiments described above is specific examples of the following aspects.

(Aspect 1) A mass spectrometer according to an aspect may include

an ionization chamber that ionizes a sample;

a vacuum chamber into which ions generated in the ionization chamber are introduced;

a partition wall that partitions the ionization chamber from the vacuum chamber;

a connection pipe that penetrates the partition wall, and communicatively connects the ionization chamber to the vacuum chamber;

a heating block that is arranged in the ionization chamber, and heats the connection pipe by surrounding an outer periphery of the connection pipe; and

a flange member into which the connection pipe is inserted, and which abuts on a first end surface of the heating block, and

the flange member may include

a base portion that abuts on the first end surface of the heating block, and is arranged in the ionization chamber, and

a projection portion that projects from the base portion.

In accordance with the mass spectrometer according to Aspect 1, the connection pipe can be heated via the flange member that abuts on the heating block. Since the flange member includes the projection portion, the tip portion of the connection pipe can be heated via the projection portion.

(Aspect 2) In the mass spectrometer according to Aspect 1, the projection portion may be inserted into the vacuum chamber.

In accordance with the mass spectrometer according to Aspect 2, the tip portion of the connection pipe can be satisfactorily heated by the projection portion inserted into the vacuum chamber.

(Aspect 3) In the mass spectrometer according to Aspect 1 or Aspect 2, a tip portion of the projection portion may be located near a tip portion of the connection pipe.

In accordance with the mass spectrometer according to Aspect 3, the projection portion of the flange member extends, and thus, it is possible to satisfactorily heat a portion near the tip portion of the connection pipe.

(Aspect 4) The mass spectrometer according to any one of Aspect 1 to Aspect 3 may further include a first seal member that is arranged between the base portion and the partition wall.

In accordance with the mass spectrometer according to Aspect 4, a space between the base portion and the partition wall can be sealed by the first seal member.

(Aspect 5) The mass spectrometer according to any one of Aspect 1 to Aspect 4 may further include a pressing mechanism that presses a second end surface of the heating block toward the vacuum chamber side.

In accordance with the mass spectrometer according to Aspect 5, the heating block can be fixed in a state of being pressed against the vacuum chamber by the pressing mechanism. Accordingly, the connection pipe inserted into the heating block can be easily positioned and fixed.

(Aspect 6) The mass spectrometer according to Aspect 5 may further include a second seal member that is arranged between the pressing mechanism and the heating block.

In accordance with the mass spectrometer according to Aspect 6, a space between the pressing mechanism and the heating block can be sealed by the second seal member.

What is claimed is:

1. A mass spectrometer comprising:
an ionization chamber that ionizes a sample;
a vacuum chamber into which ions generated in the ionization chamber are introduced;
a partition wall that partitions the ionization chamber from the vacuum chamber;
a connection pipe that penetrates the partition wall, and communicatively connects the ionization chamber to the vacuum chamber;
a heating block that is arranged in the ionization chamber, and heats the connection pipe by surrounding an outer periphery of the connection pipe; and
a flange member into which the connection pipe is inserted, and which abuts on a first end surface of the heating block,
wherein the flange member includes
a base portion that abuts on the first end surface of the heating block, and is arranged in the ionization chamber, and
a projection portion that projects from the base portion.

2. The mass spectrometer according to claim 1, wherein
the projection portion is inserted into the vacuum chamber.

3. The mass spectrometer according to claim 1, wherein
a tip portion of the projection portion is located near a tip portion of the connection pipe.

4. The mass spectrometer according to claim 1, further comprising:
a first seal member that is arranged between the base portion and the partition wall.

5. The mass spectrometer according to claim 1, further comprising:
a pressing mechanism that presses a second end surface of the heating block toward the vacuum chamber side.

6. The mass spectrometer according to claim 5, further comprising:
a second seal member that is arranged between the pressing mechanism and the heating block.
